(19) United States
(12) Patent Application Publication
(10) Pub. No.: US 2012/0300917 A1
(43) Pub. Date: Nov. 29, 2012

(54) SELECTING HOLD MUSIC CORRESPONDING TO AN EXPECTED WAITING TIME

(75) Inventors: Patrick Michael Commarford, Louisville, KY (US); Lisa Seacat DeLuca, San Francisco, CA (US); James Robert Lewis, Delray Beach, FL (US)

(73) Assignee: INTERNATIONAL BUSINESS MACHINES CORPORATION, Armonk, NY (US)

(21) Appl. No.: 13/116,103

(22) Filed: May 26, 2011

(51) Int. Cl. H04M 3/428

(52) U.S. Cl. 379/207.03

(57) ABSTRACT

In one embodiment of the invention, a method for selecting hold music corresponding to an expected waiting time comprises establishing a communications link with a caller; marking a first event by placing the caller on hold; determining a waiting time between the first event and a second event; selecting a media file having a parameter corresponding to the determined waiting time; playing the media file over the established communications link to the caller; and re-determining a waiting time remaining until the second event, selecting a different media file having a parameter corresponding to the re-determined waiting time, and playing the different media file over the established communications link to the caller.

### BACKGROUND

The present invention relates to the field of telephony and more particularly to interactive voice response systems.

Computer telephony integration (CTI), or simply “computer telephone,” is the use of computers to manage telephone calls. The term is commonly used in describing the computerized services of call centers, such as those that direct a phone call to the specific extension. It is also used to describe the ability to use computers to initiate and manage phone calls.

Moving beyond simple call routing, CTI systems can include Interactive Voice Response (IVR), technology configured to accept a combination of voice telephone input and touch-tone keypad selection and to provide appropriate responses in the form of voice, fax, callback, e-mail and perhaps other media. An IVR is usually part of a larger application that includes database access. Common IVR applications include: bank and stock account balances and transfers; surveys and polls; call center forwarding; simple order entry transactions; and selective information lookup. An IVR application provides pre-recorded voice responses for appropriate situations, keypad signal logic, access to relevant data, and potentially the ability to record voice input for later handling.

In many IVR applications, a caller is required to wait in order to speak with a customer service representative or to wait for a call transfer operation. The required waiting or “on-hold” duration can range from a few seconds to many minutes.

Callers who are placed on hold by a call center can benefit from knowledge of their estimated wait times. For example, callers who are aware that they will soon be speaking to a rep can attentively stand-by. Conversely, those who know they will be on hold for several minutes or longer can engage in other activities while they wait (paying only partial attention to the audio output from their phone). When wait time is estimated to be substantial, callers can even take an opportunity to leave the phone unattended for a period of time and accomplish other tasks.

The most common method of providing this benefit to callers is through use of a verbal recording of the estimated wait time. This information often plays at the beginning of the call and users sometimes receive periodic updates. The periodic updates provide value such that callers are kept informed of their progress and updates of estimated time remaining. However, this method is problematic such that the periodic messages can be distracting. They interrupt the hold music with a human voice recording (or an artificial voice that sounds similar to human voice), which generally leads callers to momentarily believe that their wait to speak to a rep has ended. When this happens, users have to divert attention from their current task to attend to the IVR.

### BRIEF SUMMARY

In one embodiment of the invention, a method for selecting hold music corresponding to an expected waiting time comprises establishing a communications link with a caller; marking a first event by placing the caller on hold; determining a waiting time between the first event and a second event; selecting a media file having a parameter corresponding to the determined waiting time; playing the media file over the established communications link to the caller; and re-determining a waiting time remaining until the second event, selecting a different media file having a parameter corresponding to the re-determined waiting time, and playing the different media file over the established communications link to the caller.

The method may further comprise repeating the steps of re-determining a waiting time remaining until the second event, selecting a different media file having a parameter corresponding to the re-determined waiting time, and playing the different media file over the established communications link to the caller until the second event occurs.

The parameter may comprise a tempo of the content of the media file, a beat of the content of the media file, or a lyrical pace of the content of the media file.

A media file for which at least a portion of the media file has a parameter corresponding to the determined waiting time may be selected, and the portion of the media file for which the parameter corresponds to the determined waiting time may be played over the established communications link to the caller.

After the re-determining, a different media file for which at least a portion of the media file has a parameter corresponding to the re-determined waiting time may be selected, and the portion of the different media file for which the parameter corresponds to the re-determined waiting time may be played over the established communications link to the caller.

In addition to the method for selecting hold music corresponding to an expected waiting time, as described above, other aspects of the present invention are directed to corresponding systems and computer program products for selecting hold music corresponding to an expected waiting time.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a network of callers in communication with a system for selecting hold music corresponding to an expected waiting time, in accordance with an embodiment of the present invention;

FIG. 2 is a flowchart of a method of selecting hold music corresponding to an expected waiting time, in accordance with an embodiment of the present invention;

FIG. 3 is a schematic block diagram of a computer network in which embodiments of the present invention may operate; and

FIG. 4 is a schematic block diagram of a computer in the network of FIG. 3.

### DETAILED DESCRIPTION

Embodiments of the invention may provide the ability to change the beat, tempo, or pace of lyrics of hold music to indicate to the user that their call will be picked up in a certain amount of time. This may be accomplished by the repeated selection of songs with a beat, tempo, or pace of lyrics that corresponds to the current estimated wait time.

The present invention provides a control application and a database of media files. Each media file may be provided with a tag corresponding to the beat or tempo (e.g., in beats per minute (BPM)). The control application can select and play one or more media files, in whole or in part, in response to defined parameters.

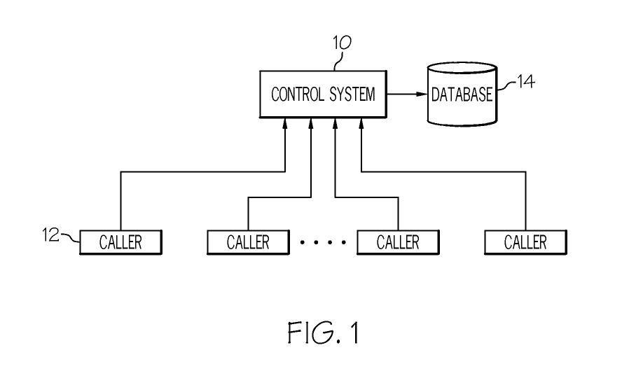

The invention can be used as part of an Interactive Voice Response communications system. An exemplary system in accordance with embodiments of the invention is illustrated in FIG. 1, wherein a control system 10 having a control application is provided for responding to external input provided by one or more callers 12 that connect with the control system over a communications network. Exemplary communications networks include wired and wireless telephone networks, as well as voice over IP and other Internet protocols. The control system 10 is in communication with a database 14 that can be integral to or remote from the control system.

The database 14 includes media files such as audio files in “.wav” or other formats, and executable files that can be played by a device or instruction set integral with or controlled by the control system 10. An exemplary set of files included in the database 14 is presented in tabular form in Table 1 below and is described in more detail below.

If a call center decides they wish to implement an embodiment of the present invention, the call center picks from a set of songs that they wish to play to callers during hold times. The tempo and beat of each song is determined and saved within a database to be recalled during caller wait times. This can be done utilizing any suitable method, such as that disclosed by U.S. Pat. No. 6,518,492 to Herberger et al.

The call center may then set preferences for how often the wait time is re-determined (after its initial determination when the caller is placed on hold) (this re-determination of wait times is discussed in more detail below). For example, the wait times may be re-determined automatically after a predefined amount of time (e.g., every 2 minutes). As another example, the wait times may be re-determined automatically when the number of callers waiting ahead of a particular caller reaches one of a plurality of predefined milestones. For example, the waiting time may be recalculated when there are fifteen callers ahead of the waiting user; then ten callers; then five callers; and then one caller. As another example, the wait times may be re-determined automatically when a predefined number of calls have been answered (e.g., after every five calls have been answered).

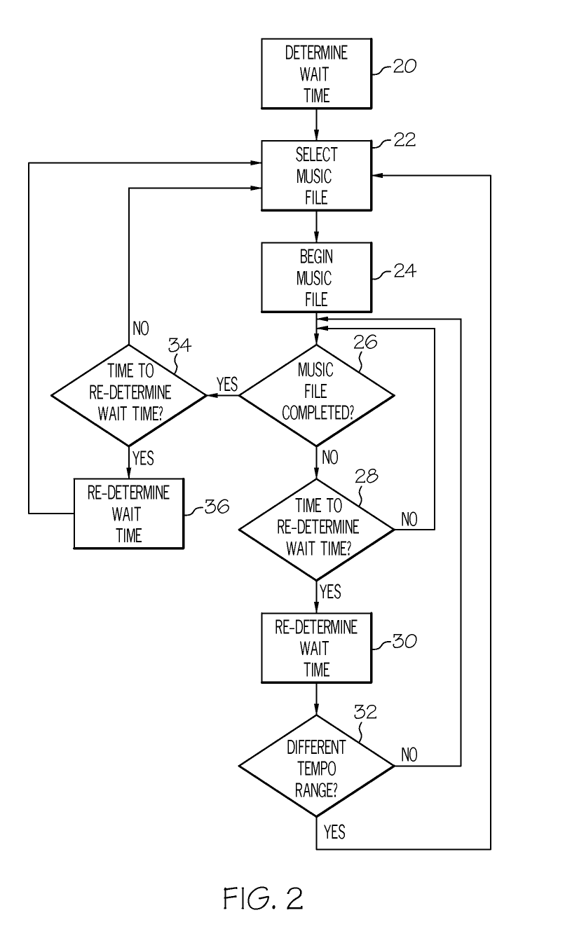

Referring now to FIG. 2, a flowchart of a method of selecting hold music corresponding to an expected waiting time is illustrated in accordance with an embodiment of the present invention. When a caller calls into the call center, the estimated wait time is determined (using any suitable method of determining wait times) (block 20). An appropriate song is selected from the database (block 22) and played for the appropriate caller (block 24). The song may be selected based on the beat of the song (a slower beat might correspond to a longer wait time and a faster beat might correspond to a shorter wait time), the tempo of the song (a slower tempo might correspond to a longer wait time and a faster tempo might correspond to a shorter wait time), or the pace of the singer's lyrics (faster speaking (regardless of tempo of the song) might correspond to a shorter wait time).

There are multiple ways to structure the data to enable the selection of an appropriate song. For example, the database may contain a table of all of the available songs and the corresponding tempo (in beats per minute (BPM)) for each. An example of such a table is shown below in Table 1, with four songs each having a different tempo. In a real world application of an embodiment of the invention, such a table would likely have many more songs. In such an example, the database may have another table which indicates the correspondence between the tempo of a song (possibly using a range of tempos) and a wait time (possibly using a range of wait times). An example of such a table is shown in Table 2. Table 2 shows that songs with a tempo of 80 BPM or less may be used for wait times greater than 15 minutes; songs with a tempo of between 81 and 120 BPM may be used for wait times between 5 and 15 minutes; songs with a tempo of between 121 and 160 BPM may be used for wait times between 5 and 1 minutes; and songs with a tempo of greater than 160 BPM may be used for wait times less than 1 minute.

TABLE 1

| Music File Name | Beats Per Minute |
|---|---|
| music1.wav | 60 |
| music2.wav | 100 |
| music3.wav | 150 |
| music4.wav | 200 |

TABLE 2

| BPM | BPM | Hold time | Hold time |
|---|---|---|---|
| minimum | maximum | minimum | maximum |
| — | 80 | 15:01 | — |
| 81 | 120 | 5:01 | 15:00 |
| 121 | 160 | 1:01 | 5:00 |
| 161 | — | — | 1:00 |

The user continues to wait while the selected song continues to play. The system may continue to monitor whether the selected music has finished playing (block 26). If not, the system determines if it is time to re-determine the wait time (block 28). Whether it is time to re-determine the wait time may be based, as discussed above, on preferences set by the call center. If it is not time to re-determine the wait time, the system waits (by looping through blocks 26 and 28) until either the selected song is completed or it is time to re-determine the wait time. If it is time to re-determine the wait time, the current wait time is re-determined (block 30). At this point, it may be desirable to determine if the new wait time would result in the selection of a song that falls into a different tempo range (block 32). This may depend on, among other factors, the sizes of the ranges (both the BPM and the hold time ranges) of the data in Table 2. For example, if the prior wait time was 14 minutes and the new wait time is 7 minutes, the current data in Table 2 would indicate that the current song could continue to play as the tempo range has not changed. However, if the prior wait time was 6 minutes and the new wait time is 3 minutes, the current data in Table 2 would indicate that the tempo range has changed and a new song should be selected (block 22) in that new tempo range.

If it is determined at block 26 that the selected music file has finished playing, the system determines if it is time to re-determine the wait time (block 34) (based on the same criteria used in block 28). If it is not time to re-determine the wait time, the system selects a new music file in the same tempo range as the song that just finished playing (block 22) and plays that newly selected song (block 24). If it is determined at block 34 to be time to re-determine the wait time, the current wait time is re-determined (block 36) and the system selects a new music file in the appropriate tempo range (block 22) and plays that newly selected song (block 24). While either block 34 or the combination of blocks 34 and 36 both proceed to block 22, the song selected at block 22 may vary depending on whether only block 34 was executed (in which case the system selects a new music file in the same tempo range as the song that just finished playing) or whether blocks 34 and 36 were executed (in which case the system selects a new music file in whatever tempo range is appropriate to the wait time that was re-determined at block 36).

After the initial determination of wait time at block 20, blocks 22-36 will continue to execute as described above, repeatedly re-determining the wait times and selecting songs with the appropriate tempo, until the caller's call is answered. It should be appreciated that the caller's call may be answered at any point along the execution of the flowchart of FIG. 2, and that the execution of the flowchart will terminate (for that caller) when the call is answered.

As an example of a use of an embodiment of the invention, Bob calls into Acme Cellular and is met with some hold music. The music is very slow elevator music. Bob recognizes instantly that there is likely a long wait so he places the call on speakerphone and continues his other work. The music changes while he waits but Bob is not distracted from his other tasks as the music continues. Bob steps away from his desk to go to the bathroom and grab a coffee since the music pace is still relatively slow. When Bob gets back to his desk the music is more upbeat popular music. The music then turns into a very fast rap song, immediately alerting Bob that someone will be answering soon. He knows to stay close to his phone.

The system of embodiments of the invention could explain how the tempo of the hold music indicates wait times when the user first calls in. Alternatively the system could recognize a new caller and only tell those new callers about this feature.

Alternative embodiments of the invention could use continuous music with a pace that increases relative to estimated wait time. Each song might not have one tempo but a flexible tempo, in which case that song can either be: (a) ignored; (b) partially played when desired tempo section is necessary; or (c) the tempo can be increased. Alternative embodiments of the invention could use songs that get faster as the songs play. Further alternative embodiments of the invention could select a particular music file and play the selected music file at different tempos depending on the wait time. Yet another alternative embodiment could select a particular music file that has different portions with different tempos, and playing a particular portion of the music file depending on the wait time.

Embodiments of the invention may provide several advantages over the prior art, such as enabling the user to always have an understanding of how much longer they are likely to have to wait, no interruption of music with a message telling the user how much time is remaining, preventing the interruption to the caller's concentration that occurs when a system-generated voice interrupts a call to tell the caller the current wait time, and enabling a user to instantly know whether the user has time to leave his/her desk or whether the user should stay close to the phone.

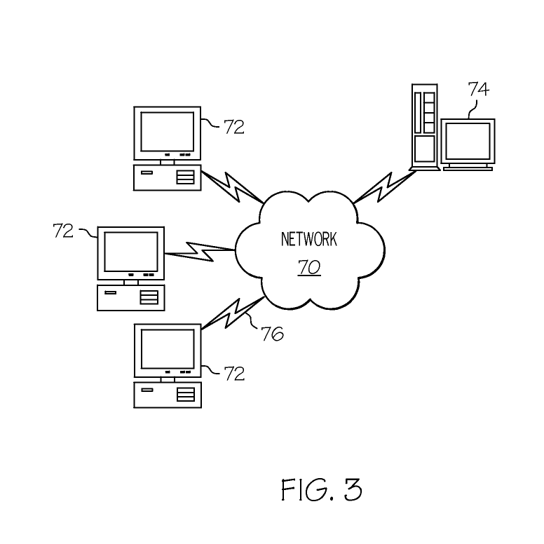

FIG. 3 is a schematic block diagram of a computer network in which embodiments of the present invention may operate. Computers 72 and server 74 provide processing, storage, and input/output devices executing application programs and the like. Computers 72 may be linked over communication link 76 through communications network 70 to each other and to other computing devices, including servers 74. Communications network 70 can be part of the Internet, a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. However, computers 72 and servers 74 may be linked over any suitable communication network. In the system of FIG. 3, the control system 10 of FIG. 1 could comprise a server such as server 74, and voice over IP calls could originate from computers 72. Alternatively, network 70 could be a public switched telephone network.

In addition to the client-server arrangement of FIG. 3, embodiments of the invention may operate in any client-server arrangement or in any networked arrangement in which resources that originate communications and resources that receive communications may reside on separate elements in a network. For example, embodiments of the invention may operate in a mobile communications/data architecture (such as a mobile telecommunications network adhering to the International Mobile Telecommunications-2000 (also termed 3G) or IMT-Advanced (also termed 4G) standards), in which a mobile telecommunications device (e.g., cell/mobile telephone) communicates.

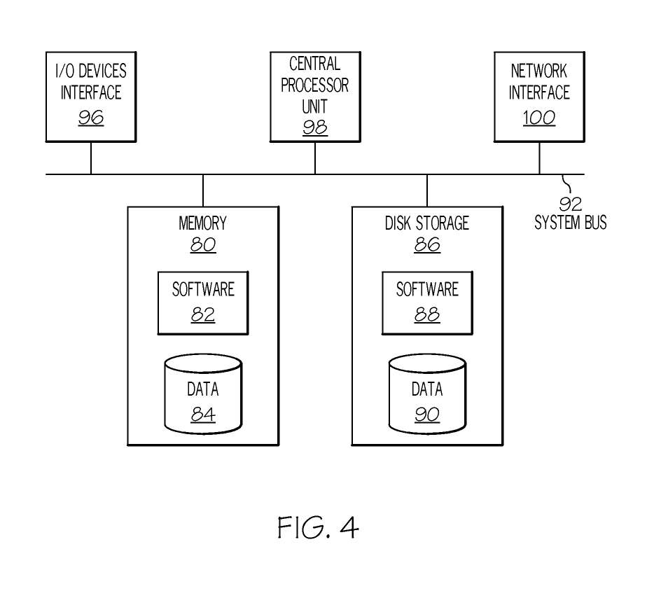

FIG. 4 is a diagram of one possible internal structure of a computer (e.g., computer 72) or server in the system of FIG. 3. Each computer typically contains system bus 92, where a bus is a set of hardware lines used for data transfer among the components of a computer. Bus 92 is essentially a shared conduit that connects different elements of a computer system (e.g., processor, disk storage, memory, input/output ports, network ports, etc.) that enables the transfer of information between the elements. Attached to system bus 92 is I/O device interface 96 for connecting various input and output devices (e.g., displays, printers, speakers, microphones, etc.) to the computer. Alternatively, the I/O devices may be connected via one or more I/O processors attached to system bus 92. Network interface 100 allows the computer to connect to various other devices attached to a network (e.g., network 70 of FIG. 3). Memory 80 provides volatile storage for computer software instructions 82 and data 84 used to implement an embodiment of the present invention. Disk storage 86 provides non-volatile storage for computer software instructions 88 and data 90 used to implement an embodiment of the present invention. Central processor unit 98 is also attached to system bus 92 and provides for the execution of computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. If the service is also available to applications as a REST interface, then launching applications could use a scripting language like JavaScript to access the REST interface. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A method for selecting hold music corresponding to an expected waiting time, comprising:
establishing a communications link with a caller;
marking a first event by placing the caller on hold;
determining a waiting time between the first event and a second event;
selecting a media file having a parameter corresponding to the determined waiting time;
playing the media file over the established communications link to the caller; and
re-determining a waiting time remaining until the second event, selecting a different media file having a parameter corresponding to the re-determined waiting time, and playing the different media file over the established communications link to the caller.

2. The method of claim 1, further comprising repeating the steps of re-determining a waiting time remaining until the second event, selecting a different media file having a parameter corresponding to the re-determined waiting time, and playing the different media file over the established communications link to the caller until the second event occurs.

3. The method of claim 1, wherein the parameter comprises a tempo of the content of the media file.

4. The method of claim 1, wherein the parameter comprises a beat of the content of the media file.

5. The method of claim 1, wherein the parameter comprises a lyrical pace of the content of the media file.

6. The method of claim 1, wherein selecting a media file having a parameter corresponding to the determined waiting time comprises selecting a media file for which at least a portion of the media file has a parameter corresponding to the determined waiting time; and wherein playing the media file over the established communications link to the caller comprises playing the portion of the media file for which the parameter corresponds to the determined waiting time over the established communications link to the caller.

7. The method of claim 1, wherein selecting a different media file having a parameter corresponding to the re-determined waiting time and playing the different media file over the established communications link to the caller comprises selecting a different media file for which at least a portion of the media file has a parameter corresponding to the re-determined waiting time and playing the portion of the different media file for which the parameter corresponds to the re-determined waiting time over the established communications link to the caller.

8. A system for selecting hold music corresponding to an expected waiting time comprising:
a processor configured for (a) establishing a communications link with a caller; (b) marking a first event by placing the caller on hold; (c) determining a waiting time between the first event and a second event; (d) selecting a media file having a parameter corresponding to the determined waiting time; (e) playing the media file over the established communications link to the caller; and (f) re-determining a waiting time remaining until the second event, selecting a different media file having a parameter corresponding to the re-determined waiting time, and playing the different media file over the established communications link to the caller.

9. The system of claim 8, wherein the processor is further configured for repeating the steps of re-determining a waiting time remaining until the second event, selecting a different media file having a parameter corresponding to the re-determined waiting time, and playing the different media file over the established communications link to the caller until the second event occurs.

10. The system of claim 8, wherein the parameter comprises a tempo of the content of the media file.

11. The system of claim 8, wherein the parameter comprises a beat of the content of the media file.

12. The system of claim 8, wherein the parameter comprises a lyrical pace of the content of the media file.

13. The system of claim 8, wherein selecting a media file having a parameter corresponding to the determined waiting time comprises selecting a media file for which at least a portion of the media file has a parameter corresponding to the determined waiting time; and wherein playing the media file over the established communications link to the caller comprises playing the portion of the media file for which the parameter corresponds to the determined waiting time over the established communications link to the caller.

14. The system of claim 8, wherein selecting a different media file having a parameter corresponding to the re-determined waiting time and playing the different media file over the established communications link to the caller comprises selecting a different media file for which at least a portion of the media file has a parameter corresponding to the re-determined waiting time and playing the portion of the different media file for which the parameter corresponds to the re-determined waiting time over the established communications link to the caller.

15. A computer program product for selecting hold music corresponding to an expected waiting time, the computer program product comprising a computer readable storage medium having computer readable program code embodied therewith, the computer readable program code comprising:
computer readable program code configured for establishing a communications link with a caller;
computer readable program code configured for marking a first event by placing the caller on hold;
computer readable program code configured for determining a waiting time between the first event and a second event;
computer readable program code configured for selecting a media file having a parameter corresponding to the determined waiting time;
computer readable program code configured for playing the media file over the established communications link to the caller;
computer readable program code configured for re-determining a waiting time remaining until the second event, selecting a different media file having a parameter corresponding to the re-determined waiting time, and playing the different media file over the established communications link to the caller.

16. The computer program product of claim 15, further comprising:
computer readable program code configured for repeating the steps of re-determining a waiting time remaining until the second event, selecting a different media file having a parameter corresponding to the re-determined waiting time, and playing the different media file over the established communications link to the caller until the second event occurs.

17. The computer program product of claim 15, wherein the parameter comprises a tempo of the content of the media file.

18. The computer program product of claim 15, wherein the parameter comprises a beat of the content of the media file.

19. The computer program product of claim 15, wherein the parameter comprises a lyrical pace of the content of the media file.

20. The computer program product of claim 15, wherein selecting a media file having a parameter corresponding to the determined waiting time comprises selecting a media file for which at least a portion of the media file has a parameter corresponding to the determined waiting time;
wherein playing the media file over the established communications link to the caller comprises playing the portion of the media file for which the parameter corresponds to the determined waiting time over the established communications link to the caller; and
wherein selecting a different media file having a parameter corresponding to the re-determined waiting time and playing the different media file over the established communications link to the caller comprises selecting a different media file for which at least a portion of the media file has a parameter corresponding to the re-determined waiting time and playing the portion of the different media file for which the parameter corresponds to the re-determined waiting time over the established communications link to the caller.
